(19) United States
(12) Patent Application Publication
(10) Pub. No.: US 2018/0175894 A1
(43) Pub. Date: Jun. 21, 2018

(54) COMMUNICATION DEVICE AND COMMUNICATION METHOD

(71) Applicant: FUJITSU LIMITED, Kawasaki-shi (JP)

(72) Inventor: Yuichi UTSUNOMIYA, Kawasaki (JP)

(73) Assignee: FUJITSU LIMITED, Kawasaki-shi (JP)

(21) Appl. No.: 15/824,654

(22) Filed: Nov. 28, 2017

(30) Foreign Application Priority Data
Dec. 19, 2016 (JP) 2016-245893

(51) Int. Cl. H04B 1/10; H04B 1/04; H04B 1/525

(52) U.S. Cl. CPC H04B 1/109; H04B 1/0475; H04B 1/12; H04B 2001/1072; H04B 1/525

(57) ABSTRACT

There is provided a communication device configured to limit a frequency band of a transmission signal including a plurality of signals to be wirelessly transmitted via an antenna at different frequencies to a frequency band allocated to the transmission signal in advance, generate, based on the plurality of signals included in the transmission signal, a cancellation signal corresponding to intermodulation distortion to be generated by intermodulation of the plurality of signals, transmit the transmission signal having the limited frequency band for the antenna and transmit a signal received via the antenna, and synthesize the transmission signal with the cancellation signal, wherein the synthesized transmission signal is wirelessly transmitted via the antenna at the different frequencies.

### CROSS-REFERENCE TO RELATED APPLICATION

This application is based upon and claims the benefit of priority of the prior Japanese Patent Application 2016-245893, filed on Dec. 19, 2016, the entire contents of which are incorporated herein by reference.

### FIELD

The embodiments discussed herein are related to a communication device and a communication method.

### BACKGROUND

Traditionally, a duplexer is installed in a radio communication device having an antenna for transmission and reception. Specifically, if the frequency of a transmission signal to be transmitted is different from the frequency of a received signal, a transmission path included in the radio communication device and a reception path included in the radio communication device are electrically separated from each other by connecting the duplexer to the antenna. This may suppress the interference of the transmission signal with the received signal.

The duplexer includes a filter and a phase shifter. To downsize the duplexer, a circulator is used instead of the phase shifter in some cases. However, when a transmission signal with large power is input to the phase shifter or circulator that is a passive element, the transmission signal may be distorted. Especially, if the transmission signal includes signals to be wirelessly transmitted at different frequencies, intermodulation distortion (IMD) may occur in the phase shifter or the circulator. Even in a radio communication device in which a transmission path and a reception path are electrically separated from each other by a duplexer, it is difficult to completely separate the paths from each other. Thus, if a frequency component of intermodulation distortion that has occurred in the duplexer is in a frequency band of a received signal, the quality of the reception may be reduced due to the intermodulation distortion component that has leaked in the reception path. To avoid this, a technique for approximately reproducing the intermodulation distortion component based on the transmission signal and using a reproduced signal to offset the intermodulation distortion component included in the received signal or another technique has been studied.

An example of related art is Japanese National Publication of International Patent Application No. 2015-530787.

Another example of related art is “Kei Matsutani and four other persons, “A Novel 4-Port Lumped Element Circulator for High-isolation Front-end system”, The Institute of Electronics, Information and Communication Engineers (IEICE), IEICE Technical Report 116(51), P11-14, 2016 May 19”.

### SUMMARY

According to an aspect of the invention, a communication device includes a memory, a processor coupled to the memory and the processor configured to, generate a transmission signal including a plurality of signals to be wirelessly transmitted via an antenna at different frequencies, receive a reception signal, and generate, based on the plurality of signals included in the transmission signal, a cancellation signal corresponding to intermodulation distortion to be generated by intermodulation of the plurality of signals, a transmission filter configured to limit a frequency band of the transmission signal generated by the processor to a frequency band allocated to the transmission signal in advance, a reception filter configured to limit a frequency band of the reception signal to be received by the processor to a frequency band allocated to the reception signal in advance, a branch circuit configured to transmit the transmission signal passed through the transmission filter for the antenna and transmit the reception signal received via the antenna to the reception filter, and a synthesizer configured to synthesize the transmission signal transmitted from the branch circuit with the cancellation signal generated by the processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a communication device according to a first embodiment;

FIG. 2 is a diagram illustrating an example of the frequency spectrum of a transmission signal output from a PA;

FIG. 3 is a diagram illustrating an example of the frequency spectrum of the transmission signal output from a transmission filter;

FIG. 4 is a diagram illustrating an example of the frequency spectrum of the transmission signal output from a branch circuit;

FIG. 5 is a diagram illustrating an example of the frequency spectrum of a replica signal that has passed through a bandpass filter;

FIG. 6 is a diagram illustrating an example of the frequency spectrum of the transmission signal output from a synthesizer;

FIG. 7 is a flowchart of an example of a transmission operation of the communication device according to the first embodiment;

FIG. 8 is a block diagram illustrating an example of a communication device according to a second embodiment;

FIG. 9 is a diagram illustrating an example of the frequency spectrum of a transmission signal output from the synthesizer;

FIG. 10 is a diagram illustrating an example of the frequency spectrum of the transmission signal output from the branch circuit;

FIG. 11 is a block diagram illustrating an example of a communication device according to a third embodiment;

FIG. 12 is a diagram illustrating an example of the frequency spectrum of a transmission signal output from a bandpass filter;

FIG. 13 is a flowchart of an example of a transmission operation of the communication device according to the third embodiment;

FIG. 14 is a diagram illustrating an example of hardware of each of RRHs; and

FIG. 15 is a diagram illustrating an example of hardware of each of BBUs.

### DESCRIPTION OF EMBODIMENTS

A reduction in the quality of reception may be suppressed by canceling an intermodulation distortion component that has occurred in a frequency band of a received signal. The intermodulation distortion component that has occurred in a duplexer, however, is added to a transmission signal and transmitted from an antenna. Thus, if the power of the intermodulation distortion component is large, it is difficult to cause the frequency spectrum of the transmission signal to satisfy a defined spectrum mask.

Hereinafter, embodiments of a technique for suppressing an intermodulation distortion component added to a transmission signal including multiple transmission signals to be wirelessly transmitted at different frequencies are described in detail with reference to the accompanying drawings. Techniques disclosed herein are not limited by the following embodiments.

### First Embodiment

### Communication Device 10

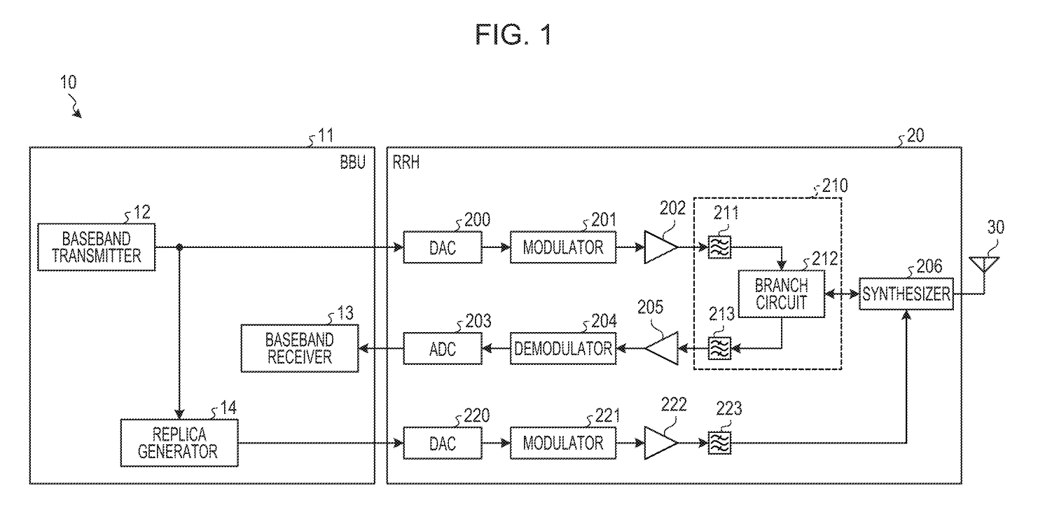

FIG. 1 is a block diagram illustrating an example of a communication device 10 according to a first embodiment. The communication device 10 includes a baseband unit (BBU) 11, a remote radio head (RRH) 20, and an antenna 30, as illustrated in FIG. 1.

The BBU 1 includes a baseband transmitter 12, a baseband receiver 13, and a replica generator 14. The baseband transmitter 12 executes a baseband process such as encoding on a transmission signal including a plurality of signals to be wirelessly transmitted at different frequencies and outputs the transmission signal after the process to the replica generator 14 and the RRH 20. In the first embodiment, the transmission signal includes a signal to be wirelessly transmitted at a frequency f₁ and a signal to be wirelessly transmitted at a frequency f₂. The baseband transmitter 12 is an example of a transmitter. The baseband receiver 13 receives a received baseband signal output from the RRH 20 and executes a baseband process such as decoding on the received signal. The baseband receiver 13 is an example of a receiver.

The replica generator 14 generates, based on the a plurality of signals that are included in the transmission signal output from the baseband transmitter 12 and are to be wirelessly transmitted at the different frequencies, a replica signal corresponding to intermodulation distortion that has occurred due to intermodulation of the plurality of signals. Specifically, the replica generator 14 generates the replica signal y according to the following Equation (1), for example.

y=A·Tx₁·Tx₁·conj(Tx₂) (1)

The Equation (1) indicates a third-order intermodulation distortion component with a frequency of (2×f₁−f₂). In Equation (1), A is a coefficient indicating the amplitude and phase of the replica signal y, Tx₁ indicates the signal included in the transmission signal and to be wirelessly transmitted at the frequency f₁, and Tx₂ indicates the signal included in the transmission signal and to be wirelessly transmitted at the frequency f₂. In Equation (1), conj(x) indicates a complex conjugate of x.

The first embodiment describes the cancellation of the third-order intermodulation distortion component with the frequency of (2×f₁−f₂). The cancellation of a third-order intermodulation distortion component with the frequency of (2×f₂−f₁) may be achieved by exchanging “Tx₁” with “Tx₂” in the aforementioned Equation 1 in the same manner as the cancellation of the third-order intermodulation distortion component with the frequency of (2×f₁−f₂). Although the first embodiment describes the cancellation of the third-order intermodulation distortion components that have occurred due to the plurality of signals included in the transmission signal and to be wirelessly transmitted at the different frequencies, techniques disclosed in the first embodiment may be applied to the cancellation of a quinary or more odd-numbered order intermodulation distortion component as another example.

The replica generator 14 outputs the replica signal generated based on the aforementioned Equation (1) to the RRH 20. The replica generator 14 is an example of a generator. The replica signal is an example of a cancellation signal.

The RRH 20 includes a digital-to-analog converter (DAC) 200, a modulator 201, a power amplifier (PA) 202, an analog-to-digital converter (ADC) 203, a demodulator 204, a low noise amplifier (LNA) 205, and a synthesizer 206. The RRH 20 also includes a branching filter 210, a DAC 220, a modulator 221, an amplifier 222, and a bandpass filter 223.

The DAC 200 converts the transmission signal output from the baseband transmitter 12 included in the BBU 11 from a digital signal to an analog signal and outputs the analog transmission signal to the modulator 201. The modulator 201 executes processes such as modulation and up-conversion on the analog transmission signal converted by the DAC 200. The PA 202 amplifies the transmission signal subjected to the processes such as the modulation by the modulator 201 and outputs the amplified transmission signal to the branching filter 210.

The LNA 205 amplifies a received signal output from the branching filter 210. The demodulator 204 executes processes such as demodulation and down-conversion on the received signal amplified by the LNA 205. The ADC 203 converts the received signal subjected to the processes such as the demodulation by the demodulator 204 from an analog signal to a digital signal. The received digital signal converted by the ADC 203 is decoded by the baseband receiver 13 included in the BBU 11.

The DAC 220 converts the replica signal generated by the replica generator 14 included in the BBU 11 from a digital signal to an analog signal and outputs the analog replica signal to the modulator 221. The modulator 221 executes processes such as modulation and up-conversion on the analog replica signal converted by the DAC 220. The amplifier 222 amplifies the replica signal subjected to the processes such as the modulation by the modulator 221. In the amplifier 222, a gain that compensates for a signal loss within a signal path extending from the DAC 220 through the modulator 221 and the bandpass filter 223 to the synthesizer 206 is set, for example. The bandpass filter 223 limits a frequency band of the replica signal amplified by the amplifier 222 to a frequency band corresponding to the frequencies of the intermodulation distortion components to be canceled. The replica signal whose frequency band has been limited by the bandpass filter 223 is output to the synthesizer 206. The bandpass filter 223 is an example of a first bandpass filter.

The branching filter 210 includes a transmission filter 211, a branch circuit 212, and a reception filter 213. In the first embodiment, the branching filter 210 is, for example, a duplexer. The transmission filter 211 limits a frequency band of the transmission signal amplified by the PA 202 to a frequency band allocated to the transmission signal in advance and outputs the transmission signal to the branch circuit 212. The reception filter 213 limits a frequency band of the received signal output from the branch circuit 212 to a frequency band allocated to the received signal in advance and outputs the received signal to the LNA 205.

The branch circuit 212 outputs, to the antenna 30 via the synthesizer 206, the transmission signal whose frequency band has been limited by the transmission filter 211. In addition, the branch circuit 212 outputs the signal received via the antenna 30 and the synthesizer 206 to the reception filter 213. In the first embodiment, the branch circuit 212 includes, for example, a passive device such as a phase shifter or a directional coupler. Examples of the directional coupler are a circulator and an isolator.

The synthesizer 206 synthesizes the transmission signal output from the branch circuit 212 with the replica signal whose frequency band has been limited by the bandpass filter 223. Specifically, the synthesizer 206 synthesizes the transmission signal output from the branch circuit 212 with a signal obtained by reversing the waveform of the replica signal whose frequency band has been limited by the bandpass filter 223. This synthesis cancels the distortion components added to the transmission signal output from the branch circuit 212. Then, the synthesizer 206 transmits the transmission signal synthesized with the replica signal via the antenna 30.

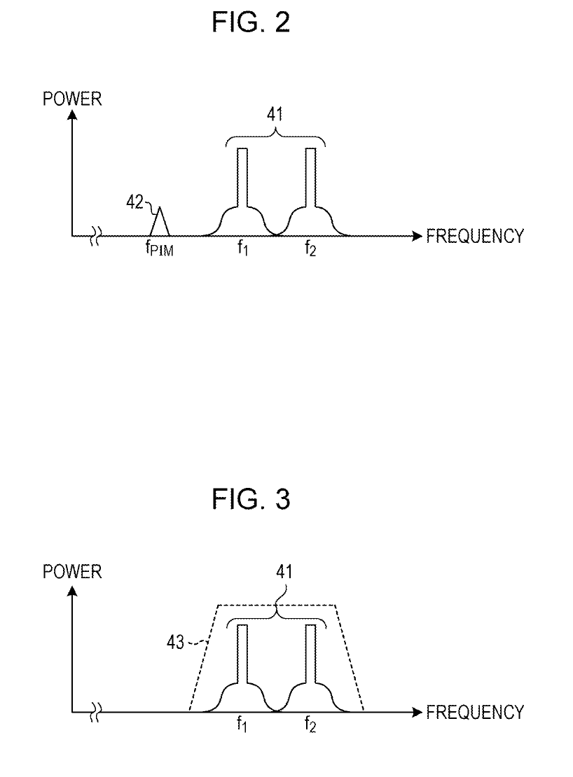

Frequency components of the transmission signal are described below. FIG. 2 is a diagram illustrating an example of the frequency spectrum of the transmission signal output from the PA 202. In order to increase a power efficiency, the PA 202 is set in such a manner that the PA 202 operates near a saturated region of input and output characteristics of the PA 202. Thus, if the power of the transmission signal is large, the distortion components are added to the transmission signal amplified by the PA 202. In the first embodiment, since the transmission signal includes the signal to be wirelessly transmitted at the frequency f₁ and the signal to be wirelessly transmitted at the frequency f₂, the intermodulation distortion components with the frequencies of (2×f₁−f₂) and (2×f₂−f₁) are added to the transmission signal amplified by the PA 202, for example. FIG. 2 illustrates the frequency spectrum of an intermodulation distortion component 42 with the frequency f_{PIM} of (2×f₁−f₂).

A frequency band of a transmission signal 41 amplified by the PA 202 and having the intermodulation distortion component 42 added thereto is limited by the transmission filter 211. FIG. 3 is a diagram illustrating an example of the frequency spectrum of the transmission signal output from the transmission filter 211. The intermodulation distortion component 42 that is a signal with the frequency that is not in a passband 43 of the transmission filter 211 is attenuated and the transmission signal 41 including the signals to be wirelessly transmitted at the frequencies that are in the passband 43 of the transmission filter 211 passes through the transmission filter 211. Thus, the transmission signal 41 is output from the transmission filter 211.

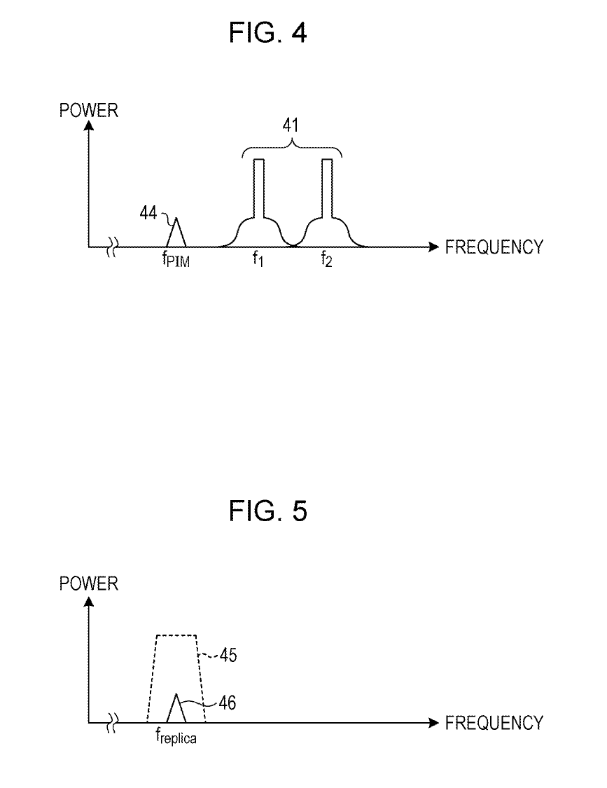

The transmission signal 41 that has passed through the transmission filter 211 is input to the branch circuit 212. If the power of the transmission signal 41 is large, a distortion component is added to the transmission signal 41 in the branch circuit 212, as illustrated in FIG. 4, for example. In the first embodiment, since the transmission signal includes the signal to be wirelessly transmitted at the frequency f₁ and the signal to be wirelessly transmitted at the frequency f₂, the transmission signal 41 that has passed through the branch circuit 212 has, added thereto, the intermodulation distortion components with the frequencies of (2×f₁−f₂) and (2×f₂−f₁), for example. FIG. 4 illustrates the frequency spectrum of the transmission signal 41 and the frequency spectrum of an intermodulation distortion component 44 with the frequency f_{PIM} of (2×f₁−f₂). The transmission signal 41 having the intermodulation distortion component 44 added thereto in the branch circuit 212 is input to the synthesizer 206.

FIG. 5 is a diagram illustrating an example of the frequency spectrum of a replica signal 46 that has passed through the bandpass filter 223. A frequency band of the replica signal 46 amplified by the amplifier 222 is limited by the bandpass filter 223, as illustrated in FIG. 5, for example. A signal with a frequency that is not in a passband 45 of the bandpass filter 223 is attenuated and the replica signal 46 with a frequency f_{replica} that is in the passband 45 of the bandpass filter 223 passes through the bandpass filter 223. Thus, the replica signal 46 is output from the bandpass filter 223.

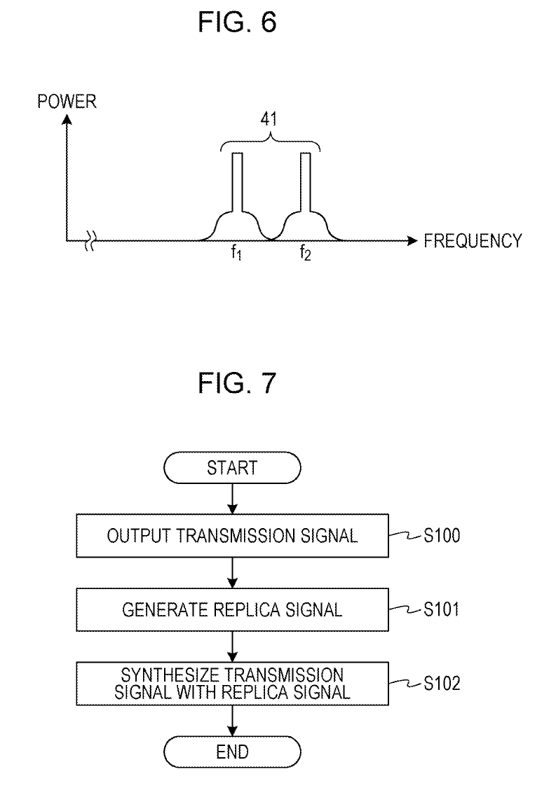

The synthesizer 206 synthesizes the transmission signal 41 having the intermodulation distortion component 44 added thereto in the branch circuit 212 with the signal obtained by reversing the waveform of the replica signal 46 that has passed through the bandpass filter 223. The intermodulation distortion component 44 added due to the branch circuit 212 is canceled by the replica signal 46 synthesized by the synthesizer 206. Thus, the transmission signal 41 in which the intermodulation distortion component 44 has been suppressed is output to the antennal 30 from the synthesizer 206, as illustrated in FIG. 6, for example. Then, the transmission signal 41 output from the synthesizer 206 is transmitted via the antenna 30.

### Transmission Operation

FIG. 7 is a flowchart of an example of a transmission operation of the communication device 10 according to the first embodiment. Every time the communication device 10 receives a transmission signal, the communication device 10 executes the transmission operation indicated in the flowchart.

First, the baseband transmitter 12 executes the baseband process such as the encoding on a transmission signal including a plurality of signals to be wirelessly transmitted at different frequencies and outputs the transmission signal after the process to the replica generator 14 and the RRH 20 (in S100). The transmission signal output to the RRH 20 is converted by the DAC 200 from a digital signal to an analog signal, modulated by the modulator 201, and amplified by the PA 202. A frequency band of the transmission signal amplified by the PA 202 is limited by the transmission filter 211, and the transmission signal is output to the synthesizer 206 via the branch circuit 212.

The replica generator 14 generates a replica signal using the plurality of signals to be wirelessly transmitted at the different frequencies and included in the transmission signal output from the baseband transmitter 12 (in S101). The replica signal y generated by the replica generator 14 is converted by the DAC 220 from a digital signal to an analog signal, modulated by the modulator 221, and amplified by the amplifier 222. A frequency band of the replica signal y amplified by the amplifier 222 is limited by the bandpass filter 223, and the replica signal is output to the synthesizer 206.

Then, the synthesizer 206 synthesizes the transmission signal output from the branch circuit 212 with the replica signal y that has passed through the bandpass filter 223 (in S102). Specifically, the synthesizer 206 synthesizes the transmission signal output from the branch circuit 212 with a signal obtained by reversing the waveform of the replica signal y that has passed through the bandpass filter 223. Thus, the transmission signal in which intermodulation distortion components have been canceled is transmitted from the antenna 30.

### Effects of First Embodiment

As is apparent from the above description, the communication device 10 according to the first embodiment includes the baseband transmitter 12, the baseband receiver 13, the branching filter 210, the replica generator 14, and the synthesizer 206. The baseband transmitter 12 outputs a transmission signal including a plurality of signals to be wirelessly transmitted at different frequencies. The baseband receiver 13 receives a received signal. The branching filter 210 is installed between the antenna 30 and the baseband transmitter 12 and the receiver 13. The replica generator 14 generates, based on the plurality of signals included in the transmission signal, a replica signal corresponding to intermodulation distortion that has occurred due to intermodulation of the plurality of signals. The synthesizer 206 synthesizes the transmission signal with the replica signal. The branching filter 210 includes the transmission filter 211, the reception filter 213, and the branch circuit 212. The transmission filter 211 limits a frequency band of the transmission signal output from the baseband transmitter 12 to a frequency band allocated to the transmission signal in advance. The reception filter 213 limits a frequency band of the signal received by the baseband receiver 13 to a frequency band allocated to the received signal in advance. The branch circuit 212 outputs, to the antenna 30, the transmission signal having passed through the transmission filter 211 and outputs the signal received via the antenna 30 to the reception filter 213. The synthesizer 206 synthesizes the replica signal with the transmission signal that has passed through the branch circuit 212. Thus, the communication device 10 may suppress intermodulation distortion components added to the transmission signal including the plurality of signals to be wirelessly transmitted at the different frequencies.

In addition, the communication device 10 also includes the bandpass filter 223 that limits a frequency band of the replica signal to a frequency band corresponding to the intermodulation distortion. The synthesizer 206 synthesizes the transmission signal that has passed through the branch circuit 212 with the replica signal that has passed through the bandpass filter 223. Thus, the synthesizer 206 may cancel the intermodulation distortion components added to the transmission signal with high accuracy.

### Second Embodiment

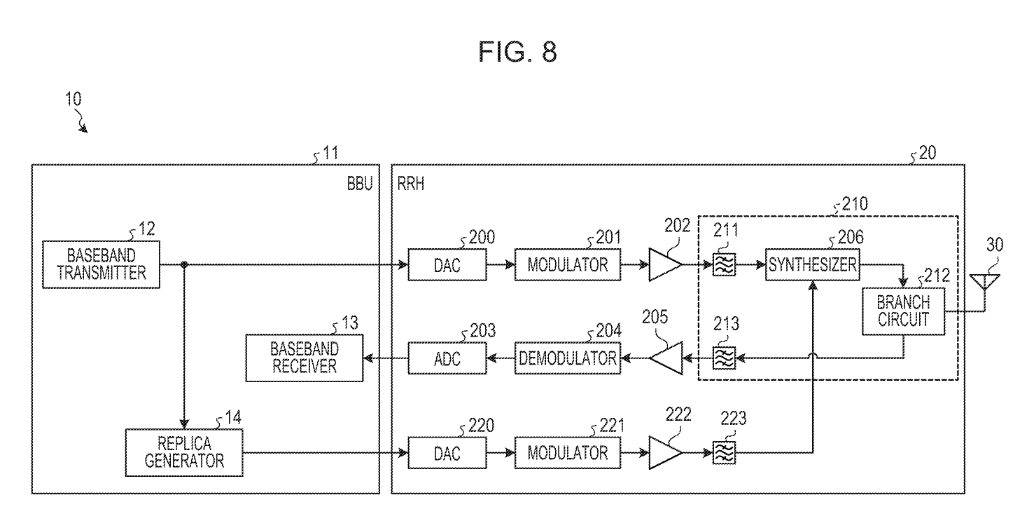

FIG. 8 is a block diagram illustrating an example of a communication device 10 according to a second embodiment. The communication device 10 according to the second embodiment is different from the communication device 10 according to the first embodiment in that a replica signal is synthesized with a transmission signal that has passed through the transmission filter 211 in the second embodiment and in that the transmission signal synthesized with the replica signal is output to the branch circuit 212 in the second embodiment. Blocks illustrated in FIG. 8 and indicated by the same reference numbers as those illustrated in FIG. 1 have functions that are the same as or similar to those of the blocks described with reference to FIG. 1, except for features described below, and a description thereof is omitted.

The branching filter 210 includes the transmission filter 211, the branch circuit 212, the reception filter 213, and the synthesizer 206. In the second embodiment, the branching filter 210 may be a single duplexer or may be configured by combining the transmission filter 211, the branch circuit 212, the reception filter 213, and the synthesizer 206.

Frequency components of the transmission signal are described below. The frequency band of the transmission signal 41 amplified by the PA 202 and having the intermodulation distortion components added thereto is limited by the transmission filter 211 as illustrated in FIG. 3, and the transmission signal 41 is output to the synthesizer 206, for example. In addition, the frequency band of the replica signal 46 amplified by the amplifier 222 is limited by the bandpass filter 223 as illustrated in FIG. 3, and the replica signal 46 is output to the synthesizer 206, for example. In the second embodiment, since the transmission signal includes the signal to be wirelessly transmitted at the frequency f₁ and the signal to be wirelessly transmitted at the frequency f₂, the replica signal 46 with the frequency f_{replica} of (2×f₁−f₂) is output to the synthesizer 206, for example.

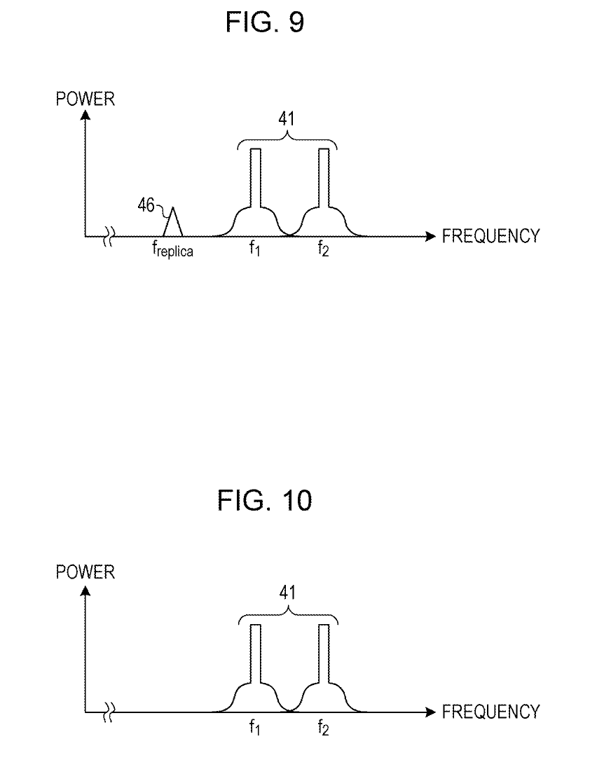

The synthesizer 206 synthesizes the transmission signal 41 whose frequency band has been limited by the transmission filter 211 with the replica signal 46 that has passed through the bandpass filter 223. Specifically, the synthesizer 206 synthesizes the transmission signal 41 that has passed through the transmission filter 211 with the signal obtained by reversing the waveform of the replica signal 46 that has passed through the bandpass filter 223. Thus, a signal obtained by adding the replica signal 46 with the frequency f_{replica} to the transmission signal 41 is generated, as illustrated in FIG. 9, for example. Then, the synthesizer 206 outputs the transmission signal 41 having the replica signal 46 added thereto to the branch circuit 212.

The transmission signal 41 having the replica signal 46 added thereto by the synthesizer 206 is input to the branch circuit 212. If the power of the transmission signal is large, a distortion component is added to the transmission signal 41 in the branch circuit 212. In the second embodiment, since the transmission signal includes the signal to be wirelessly transmitted at the frequency f₁ and the signal to be wirelessly transmitted at the frequency f₂, the transmission signal 41 that has passed through the branch circuit 212 has, added thereto, the intermodulation distortion component with the frequency of (2×f₁−f₂), for example.

However, since the transmission signal 41 has, added thereto, the signal obtained by reversing the waveform of the replica signal 46 with, for example, the frequency f_{replica} of (2×f₁−f₂), the intermodulation distortion component that has occurred due to the branch circuit 212 is canceled by the signal obtained by reversing the waveform of the replica signal 46. Thus, the transmission signal 41 4b in which the intermodulation distortion component has been suppressed is output from the branch circuit 212 to the antenna 30, as illustrated in FIG. 10, for example. The transmission signal 41 output from the branch circuit 212 is transmitted via the antenna 30.

### Effects of Second Embodiment

As is apparent from the above description, the communication device 10 according to the second embodiment includes the bandpass filter 223 that limits a frequency band of the replica signal to a frequency band corresponding to intermodulation distortion. In addition, the synthesizer 206 synthesizes the transmission signal that has passed through the transmission filter 211 with the replica signal that has passed through the bandpass filter 223. Thus, in the second embodiment, the communication device 10 may suppress the intermodulation distortion component added to the transmission signal including the plurality of signals to be wirelessly transmitted at the different frequencies.

### Third Embodiment

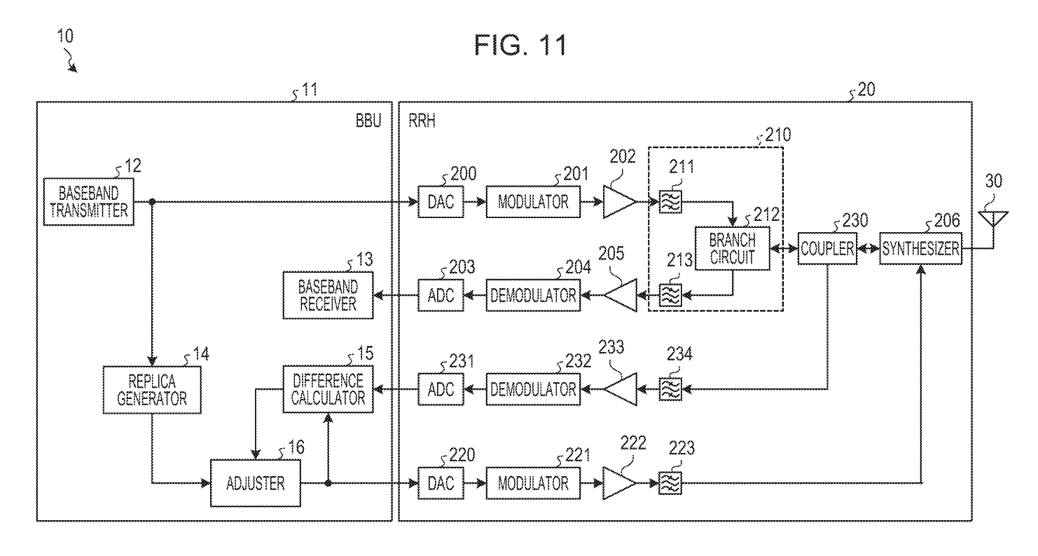

FIG. 11 is a block diagram illustrating an example of a communication device 10 according to the third embodiment. The communication device 10 according to the third embodiment is different from the communication device 10 according to the first embodiment in that the amplitude and phase of a replica signal are adjusted in the third embodiment. Features that are different from the communication device 10 according to the first embodiment are mainly described below. Thus, blocks that are illustrated in FIG. 11 and indicated by the same reference numbers as those illustrated in FIG. 1 have functions that are the same as or similar to those of the blocks described with reference to FIG. 1, and a description thereof is omitted.

A BBU 11 according to the third embodiment includes the baseband transmitter 12, the baseband receiver 13, the replica generator 14, a difference calculator 15, and an adjuster 16. The difference calculator 15 calculates the difference between an intermodulation distortion component output from an RRH 20 according to the third embodiment and a replica signal having an amplitude and a phase that have been adjusted by the adjuster 16. The difference calculator 15 is an example of a calculator. The adjuster 16 adjusts, based on the difference calculated by the difference calculator 15, the amplitude and phase of the replica signal generated by the replica generator 14 in such a manner that the difference is reduced. For the adjustment of the amplitude and the phase by the adjuster 16, the least square method, the least mean square method, or the like may be used, for example.

The RRH 20 according to the third embodiment includes the DAC 200, the modulator 201, the PA 202, the ADC 203, the demodulator 204, the LNA 205, the synthesizer 206, the branching filter 210, the DAC 220, the modulator 221, the amplifier 222, and the bandpass filter 223. The RRH 20 according to the third embodiment also includes a coupler 230, an ADC 231, a demodulator 232, an amplifier 233, and a bandpass filter 234.

The coupler 230 outputs, to the bandpass filter 234, a portion of a signal that has passed through the branch circuit 212. The signal output from the coupler 230 includes a transmission signal and an intermodulation distortion component that has occurred in the branch circuit 212. The bandpass filter 234 limits a frequency band of the signal output from the coupler 230 to a frequency band corresponding to the frequency of the intermodulation distortion component to be canceled. Thus, the intermodulation distortion component that has occurred in the branch circuit 212 and is included in the signal output from the bandpass filter 234 passes through the bandpass filter 234. The bandpass filter 234 is an example of a second bandpass filter.

The amplifier 233 amplifies a signal of the intermodulation distortion component that has passed through the bandpass filter 234. In the amplifier 233, a gain that compensates for a signal loss caused by coupling of the coupler 230 and a signal loss within a signal path extending from the coupler 230 through the bandpass filter 234 and the demodulator 232 to the ADC 231 is set, for example. The demodulator 232 executes processes such as demodulation and down-conversion on the signal amplified by the amplifier 233. The ADC 231 converts the signal subjected to the processes such as the demodulation by the demodulator 232 from an analog signal to a digital signal. The digital signal converted by the ADC 231 is output to the difference calculator 15 included in the BBU 11.

Frequency components of the transmission signal are described below. The frequency band of the transmission signal 41 amplified by the PA 202 and having the intermodulation distortion component added thereto is limited by the transmission filter 211 as illustrated in FIG. 3 and is output to the branch circuit 212, for example. Then, the intermodulation distortion component 44 is added to the transmission signal 41 in the branch circuit 212, as illustrated in FIG. 4, for example.

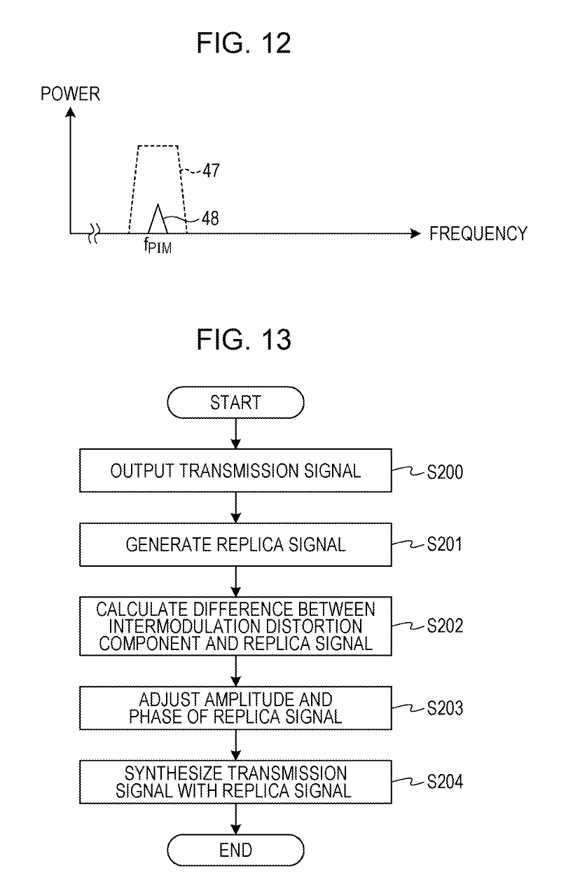

Then, a portion of a signal that includes the transmission signal 41 and the intermodulation distortion component 44 is fed back by the coupler 230 to the bandpass filter 234. Then, a frequency band of the signal fed back from the coupler 230 is limited by the bandpass filter 234, as illustrated in FIG. 12, for example. Thus, a signal with a frequency that is not in a passband 47 of the bandpass filter 234 is attenuated and an intermodulation distortion component 48 that is a signal with a frequency fplM within the passband 47 of the bandpass filter 234 is amplified by the amplifier 233, demodulated by the demodulator 232, and converted by the ADC 231 to a digital signal.

Then, the difference calculator 15 calculates the difference between the digital intermodulation distortion component 48 converted by the ADC 231 and the replica signal having the amplitude and the phase that have been adjusted by the adjuster 16. Then, the adjuster 16 adjusts, based on the difference calculated by the difference calculator 15, the amplitude and phase of the replica signal generated by the replica generator 14 in such a manner that the difference is reduced. The replica signal having the amplitude and the phase that have been adjusted by the adjuster 16 is converted by the DAC 220 to an analog signal, subjected to the modulation and the like by the modulator 221, and amplified by the amplifier 222.

Then, the frequency band of the replica signal 46 amplified by the amplifier 222 is limited by the bandpass filter 223, as illustrated in FIG. 5, for example. Then, the synthesizer 206 synthesizes the transmission signal 41 that has passed through the branch circuit 212 and the coupler 230 with the signal obtained by reversing the waveform of the replica signal 46 that has passed through the bandpass filter 223. Thus, the transmission signal 41 in which the intermodulation distortion component has been suppressed is output to the antenna 30, as illustrated in FIG. 6, for example. Then, the transmission signal 41 output from the synthesizer 206 is transmitted via the antenna 30.

In the third embodiment, the adjuster 16 adjusts the amplitude and phase of the replica signal generated by the replica generator 14 in such a manner that the difference between the intermodulation distortion component fed back by the coupler 230 and the replica signal generated by the replica generator 14 is reduced. In this manner, the amplitude and phase of the replica signal synthesized with the transmission signal are adjusted based on the intermodulation distortion component added to the transmission signal that has actually passed through the branch circuit 212. Thus, the communication device 10 according to the third embodiment may cancel, with high accuracy, the intermodulation distortion component that has occurred in the branch circuit 212.

### Transmission Operation

FIG. 13 is a flowchart of an example of a transmission operation of the communication device 10 according to the third embodiment. Every time the communication device 10 transmits a transmission signal, the communication device 10 executes the transmission operation indicated in the flowchart.

First, the baseband transmitter 12 executes the baseband process such as the encoding on a transmission signal including a plurality of signals to be wirelessly transmitted at different frequencies and outputs the transmission signal after the process to the replica generator 14 and the RRH 20 (in S200). The transmission signal output to the RRH 20 is converted by the DAC 200 from a digital signal to an analog signal, modulated by the modulator 201, and amplified by the amplifier PA 202. A frequency band of the transmission signal amplified by the PA 202 is limited by the transmission filter 211, and the transmission signal is output to the synthesizer 206 via the branch circuit 212 and the coupler 230.

The coupler 230 outputs, to the bandpass filter 234, a portion of the signal that has passed through the branch circuit 212, and the bandpass filter 234 limits a frequency band of the signal output from the coupler 230 to a frequency band corresponding to the frequency of an intermodulation distortion component to be canceled. Then, a signal of the intermodulation distortion component that has passed through the bandpass filter 234 is amplified by the amplifier 233, subjected to the processes such as the demodulation by the demodulator 232, and converted by the ADC 231 to a digital signal.

The replica generator 14 generates a replica signal y based on the aforementioned Equation (1) using the plurality of signals that are included in the transmission signal output from the baseband transmitter 12 and are to be wirelessly transmitted at the different frequencies (in S201). Then, the difference calculator 15 calculates the difference between the digital signal, converted by the ADC 231, of the intermodulation distortion component and the replica signal y having the amplitude and the phase that have been adjusted by the adjuster 16 (in S202).

Then, the adjuster 16 adjusts, based on the difference calculated by the difference calculator 15, the amplitude and phase of the replica signal y generated by the replica generator 14 in such a manner that the difference is reduced (in S203). The replica signal y having the amplitude and the phase that have been adjusted by the adjuster 16 is converted by the DAC 220 from a digital signal to an analog signal, modulated by the modulator 221, and amplified by the amplifier 222. The frequency band of the replica signal y amplified by the amplifier 222 is limited by the bandpass filter 222, and the replica signal y is output from the bandpass filter 222 to the synthesizer 206.

Then, the synthesizer 206 synthesizes the transmission signal output from the branch circuit 212 with the replica signal y that has passed through the bandpass filter 223 (in S204). Specifically, the synthesizer 206 synthesizes the transmission signal output from the branch circuit 212 with a signal obtained by reversing the waveform of the replica signal y that has passed through the bandpass filter 223. Thus, the transmission signal in which the intermodulation distortion component has been canceled is transmitted from the antenna 30.

### Effects of Third Embodiment

As is apparent from the above description, the communication device 10 according to the third embodiment includes the bandpass filter 234, the difference calculator 15, and the adjuster 16. The bandpass filter 234 limits the frequency band of the transmission signal output from the branch circuit 212 to the frequency band corresponding to the intermodulation distortion. The difference calculator 15 calculates the difference between the signal that has passed through the bandpass filter 234 and the replica signal having the amplitude and the phase that have been adjusted by the adjuster 16. The adjuster 16 adjusts the amplitude and phase of the replica signal in such a manner that the difference calculated by the difference calculator 15 is reduced. The synthesizer 206 synthesizes the replica signal adjusted by the adjuster 16 with the transmission signal that has passed through the branch circuit 212. Thus, in the third embodiment, the communication device 10 may suppress the intermodulation distortion component added to the transmission signal including the plurality of signals to be wirelessly transmitted at the different frequencies.

### Hardware

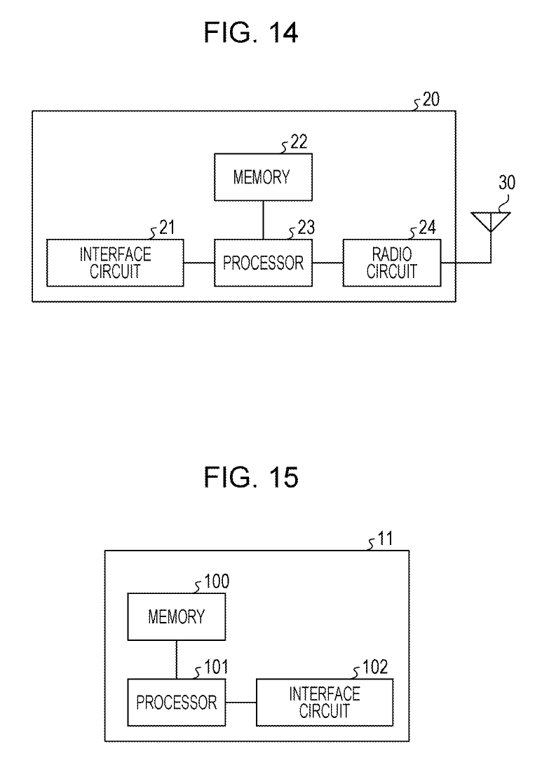

Each of the RRHs 20 according to the aforementioned embodiments is achieved by hardware illustrated in FIG. 14, for example. FIG. 14 is a diagram illustrating an example of hardware of each of the RRHs 20. Each of the RRHs 20 includes an interface circuit 21, a memory 22, a processor 23, a radio circuit 24, and the antenna 30, as illustrated in FIG. 14, for example.

The interface circuit 21 transmits and receives signals to and from the BBU 11 according to the first and second embodiments or the BBU 11 according to the third embodiment in accordance with a communication standard such as the Common Public Radio Interface (CPRI) standard, for example. The radio circuit 24 includes the DAC 200, the modulator 201, the PA 202, the ADC 203, the demodulator 204, the LNA 205, the synthesizer 206, the branching filter 210, the DAC 220, the modulator 221, the amplifier 222, and the bandpass filter 223. The radio circuit 24 also includes the coupler 230, the ADC 231, the demodulator 232, the amplifier 233, and the bandpass filter 234. The memory 22 stores a program, data, and the like that are used to achieve the functions of the RRH 20. The processor 23 executes the program read from the memory 22 and collaborates with the interface circuit 21, the radio circuit 24, and the like to achieve the functions of the RRH 20.

Each of the BBUs 11 according to the aforementioned embodiments is achieved by hardware illustrated in FIG. 15, for example. FIG. 15 is a diagram illustrating an example of hardware of each of the BBUs 11. Each of the BBUs 11 includes a memory 100, a processor 101, and an interface circuit 102, as illustrated in FIG. 15, for example.

The interface circuit 102 transmits and receives signals to and from the RRH 20 according to the first and second embodiments or the RRH 20 according to the third embodiment in accordance with a communication standard such as the CPRI standard, for example. The memory 100 stores a program, data, and the like that are used to achieve the functions of the BBU 11. The processor 101 executes the program read from the memory 100 and collaborates with the interface circuit 102 and the like to achieve the functions of the BBU 11. The functions of the BBU 11 are the functions of the baseband transmitter 12, the baseband receiver 13, the replica generator 14, the difference calculator 15, the adjuster 16, and the like.

### Others

The techniques disclosed herein are not limited to the aforementioned embodiments and may be variously changed and modified within the spirit of the disclosure.

For example, in the third embodiment, the intermodulation distortion component added to the transmission signal that has passed through the branch circuit 212 different from a circuit for a reception system is fed back, but the techniques disclosed herein are not limited to this. A portion of the intermodulation distortion component that has occurred in the branch circuit 212 and has been added to the transmission signal may leak into the reception filter 213. Thus, a bandpass filter or the like may be used to extract the intermodulation distortion component from the signal output from the ADC 203 included in a path for the reception system, for example. Then, the difference calculator 15 may calculate the difference between the extracted intermodulation distortion component and the replica signal having the amplitude and the phase that have been adjusted by the adjuster 16. In this case, the coupler 230, the ADC 231, the demodulator 232, the amplifier 233, and the bandpass filter 234 may not be installed and the size of the circuit may be reduced.

In the aforementioned embodiments, the replica generator 14 generates a replica signal having a size based on the size of a transmission signal output from the baseband transmitter 12. However, if the power of the transmission signal is small, an intermodulation distortion component that has occurred in the branch circuit 212 included in the branching filter 210 is small. If the intermodulation distortion component is small and added to the transmission signal, a spectrum mask defined in the transmission signal may be satisfied. Thus, if the power of the transmission signal is equal to or smaller than power causing the occurrence of the intermodulation distortion component with power satisfying the spectrum mask, the replica generator 14 may stop generating the replica signal. In this case, operations of the DAC 220, the modulator 221, the amplifier 222, the bandpass filter 223, and the synthesizer 206 that are included in each of the RRH 20 may be stopped. In addition, in this case, operations of the difference calculator 15, the adjuster 16, the coupler 230, the ADC 231, the demodulator 232, the amplifier 233, and the bandpass filter 234 may be stopped in the third embodiment. Thus, power consumed by the communication device 10 may be reduced.

In addition, in the third embodiment, the replica generator 14 may determine, based on the power of the intermodulation distortion component output from the ADC 231, whether or not the replica generator 14 generates the replica signal. If the replica generator 14 determines that the replica generator 14 does not generate the replica signal, operations of the difference calculator 15, the adjuster 16, the DAC 220, the modulator 221, the amplifier 222, the bandpass filter 223, and the synthesizer 206 are stopped. However, operations of the replica generator 14, the coupler 230, the ADC 231, the demodulator 232, the amplifier 233, and the bandpass filter 234 are continuously executed. If the replica generator 14 determines that the replica generator 14 generates the replica signal, the operations of the difference calculator 15, the adjuster 16, the DAC 220, the modulator 221, the amplifier 222, the bandpass filter 223, and the synthesizer 206 are restarted.

In the aforementioned embodiments, each of the communication devices 10 includes a BBU 11 and an RRH 20 that are separated from each other. Each of the communication devices 10 may include a BBU 11 and an RRH 20 that are configured as a single unit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a memory;
a processor coupled to the memory and the processor configured to:
generate a transmission signal including a plurality of signals to be wirelessly transmitted via an antenna at different frequencies;
receive a reception signal; and
generate, based on the plurality of signals included in the transmission signal, a cancellation signal corresponding to intermodulation distortion to be generated by intermodulation of the plurality of signals;
a transmission filter configured to limit a frequency band of the transmission signal generated by the processor to a frequency band allocated to the transmission signal in advance;
a reception filter configured to limit a frequency band of the reception signal to be received by the processor to a frequency band allocated to the reception signal in advance;
a branch circuit configured to transmit the transmission signal passed through the transmission filter for the antenna and transmit the reception signal received via the antenna to the reception filter; and
a synthesizer configured to synthesize the transmission signal transmitted from the branch circuit with the cancellation signal generated by the processor.

2. The communication device according to claim 1,
wherein the synthesizer is configured to synthesize the transmission signal passed through the transmission filter with the cancellation signal generated by the processor, and
wherein the branch circuit is configured to transmit the transmission signal synthesized by the synthesizer to the antenna and transmit a signal received via the antenna to the reception filter.

3. The communication device according to claim 1, further comprising:
a first bandpass filter configured to limit a frequency band of the generated cancellation signal to a frequency band corresponding to the intermodulation distortion,
wherein the synthesizer is configured to synthesize the transmission signal transmitted from the branch circuit with the cancellation signal passed through the first bandpass filter.

4. The communication device according to claim 2, further comprising:
a first bandpass filter configured to limit a frequency band of the generated cancellation signal to a frequency band corresponding to the intermodulation distortion,
wherein the synthesizer is configured to synthesize the transmission signal passed through the transmission filter with the cancellation signal passed through the first bandpass filter.

5. The communication device according to claim 3, further comprising:
a second bandpass filter configured to limit a frequency band of the transmission signal transmitted from the branch circuit to a frequency band corresponding to the intermodulation distortion,
wherein the processor is further configured to:
calculate a difference between the transmission signal passed through the second bandpass filter and the generated cancellation signal, and
adjust an amplitude and a phase of the generated cancellation signal according to the calculated difference so as to reduce the calculated difference, and
wherein the synthesizer is configured to synthesize the transmission signal passed through the branch circuit with the adjusted cancellation signal.

6. A communication method comprising:
limiting a frequency band of a transmission signal including a plurality of signals to be wirelessly transmitted via an antenna at different frequencies to a frequency band allocated to the transmission signal in advance, by a transmission filter;
generating, based on the plurality of signals included in the transmission signal, a cancellation signal corresponding to intermodulation distortion to be generated by intermodulation of the plurality of signals, by a processor;
transmitting the transmission signal having the limited frequency band for the antenna and transmitting a signal received via the antenna, by a branch circuit; and
synthesizing the transmission signal transmitted from the branch circuit with the cancellation signal generated by the processor, by the synthesizer,
wherein the synthesized transmission signal is wirelessly transmitted via the antenna at the different frequencies.
